(19) United States
(12) Patent Application Publication
(10) Pub. No.: US 2019/0183198 A1
(43) Pub. Date: Jun. 20, 2019

(54) SWEAT ABSORBING JERSEY

(71) Applicant: Seth Franklin Oringher, Rockville, MD (US)

(72) Inventor: Seth Franklin Oringher, Rockville, MD (US)

(21) Appl. No.: 16/217,737

(22) Filed: Dec. 12, 2018

Related U.S. Application Data
(60) Provisional application No. 62/598,678, filed on Dec. 14, 2017.

(51) Int. Cl. A41D 31/12; B05D 5/08

(52) U.S. Cl. CPC A41D 31/125; A41D 3/00; B05D 5/08

(57) ABSTRACT

A sports jersey or other sports garment includes a shirt made of a non-sweat absorbing material. The shirt includes a sweat absorbing material located only on an inside upper portion of the jersey shirt.

### CROSS-REFERENCE TO RELATED APPLICATION

This application claims priority under 35 U.S.C. § 119 to U.S. Provisional Application No. 62/598,678, filed on Dec. 14, 2017, the contents of which are incorporated by reference in their entirety.

### BACKGROUND

An athlete typically wears a jersey that is formed of a sweat wicking material. The sweat wicking material aids in drawing away moisture from the athlete's body during strenuous athletic activity, and provides minimal sweat absorbency. In some cases, an athlete uses the jersey to attempt to wipe away facial sweat. However, the sweat wicking material often proves insufficient in removing facial sweat from the athlete.

### SUMMARY

According to an aspect of the disclosure, a sports jersey includes a jersey shirt made of a non-sweat absorbing material, the jersey shirt having a sweat absorbing material located only on an inside upper portion of the jersey shirt.

According to an aspect of the disclosure, a method of removing sweat from a person wearing a sports jersey shirt during an athletic event includes wearing the sports jersey shirt made of a non-sweat absorbing material, the sports jersey shirt having a sweat absorbing material located only on an inside upper portion of the sports jersey shirt; lifting-up the sports jersey shirt to expose the sweat absorbing material located only on the inside of the sports jersey shirt; and wiping sweat from the person's face onto the sweat absorbing material.

### BRIEF DESCRIPTION OF THE DRAWINGS

FIG. 1 is a front view of a sweat absorbing sports jersey as described herein;

FIG. 2 is a front view of a sweat absorbing sports jersey that is disposed inside -out as described herein;

FIG. 3 is a perspective view of a sweat absorbing sports jersey as described herein;

FIG. 4 is a perspective view of a sweat absorbing sports jersey that is disposed inside-out as described herein;

FIG. 5 is a rear view of a sweat absorbing sports jersey as described herein; and

FIG. 6 is a perspective view of a sweat absorbing sports jersey as described herein.

### DETAILED DESCRIPTION

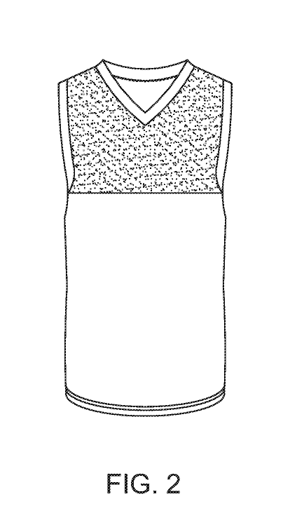

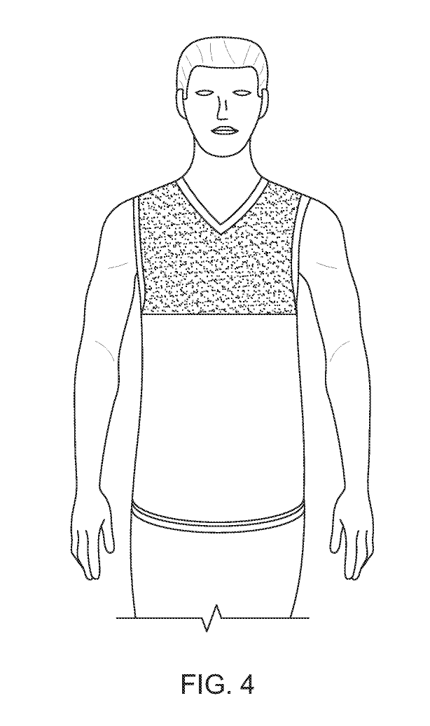

The present disclosure is directed to an improved sports jersey which an athlete wears during a sporting event. The sports jersey has a perspiration absorbing lining inside the front upper portion of the jersey. Athletes frequently lift up their jersey to wipe away sweat by using the inside of the jersey which is typically made of a nylon type material which is not sweat absorbing. Basketball players are frequently observed using their jerseys in this manner to wipe sweat off their faces during games. The jersey of the present disclosure includes an absorbent material that is secured inside the upper front panel as shown, for example, in FIGS. 2 and 4, which allows the athlete to lift up the front of the jersey while playing, and wipe the sweat off their face against the sweat absorbing material.

Other jerseys might include sweat absorbing elements on the sleeves or a towel -like appendage. Basketball jerseys, however, are sleeveless and cannot have towel-like appendages. The present disclosure incorporates a sweat absorbing liner inside the front upper panel of the jersey that the athlete can lift over his face to conveniently wipe moisture from his or her face and forehead. The sweat absorbing material can be made of, for example, cotton terry cloth, bamboo, linen-like material, as well as other sweat absorbing materials known in the art.

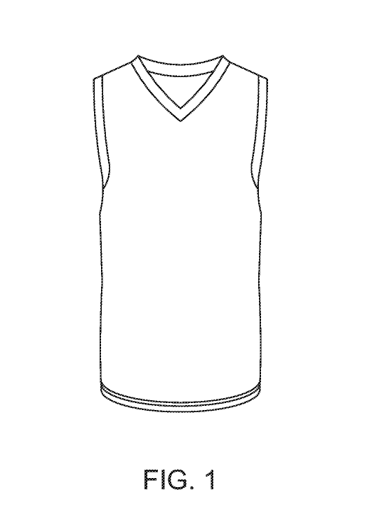

FIG. 1 is a view of a sports jersey described herein. For example, FIG. 1 depicts a sleeveless basketball jersey. Although a basketball jersey is shown in FIGS. 1-6, it should be understood that implementations herein are applicable to other types of sports jerseys including baseball jerseys, football jerseys, hockey jerseys, soccer jerseys, etc. Further, implementations herein are applicable to other types of shirts and garments, and are not necessarily limited to sports jerseys.

FIG. 2 is a view of a sports jersey that is inside-out. As shown, the sports jersey includes a jersey shirt made of a non-sweat absorbing material, and that has a sweat absorbing material located only on an inside upper portion of the jersey shirt.

The non-sweat absorbing material may include a first material, and the sweat absorbing material may include a second material that is different from the first material. For example, the non-sweat absorbing material may include nylon, polyester, and/or the like. Additionally, the swear absorbing material may include cotton, terry cloth, bamboo, linen, and/or the like.

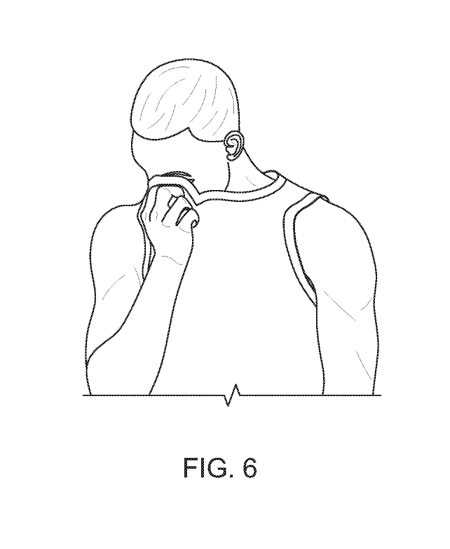

As shown in FIG. 2, the sweat absorbing material is located only on an inside upper portion of the jersey shirt. In this way, and as described in more detail in association with FIG. 6, an athlete may manipulate the jersey to expose the sweat absorbing material to wipe sweat from the athlete's face. As shown in FIG. 2, the inside upper portion extends, in a vertical direction of the jersey, from a shoulder region of the jersey to a position located near the athlete's breast. As further shown in FIG. 2, the inside upper portion extends, in a horizontal direction of the jersey, substantially an entire width of the jersey.

Alternatively, in other embodiments, the inside upper portion includes a differently sized and/or arranged portion than as shown in FIG. 2. For example, the inside upper portion may include a rectangular portion, a square portion, a circular portion, and/or the like. In some cases, the inside upper portion may be asymmetric. For example, the inside upper portion may be disposed on a single side of the sports jersey.

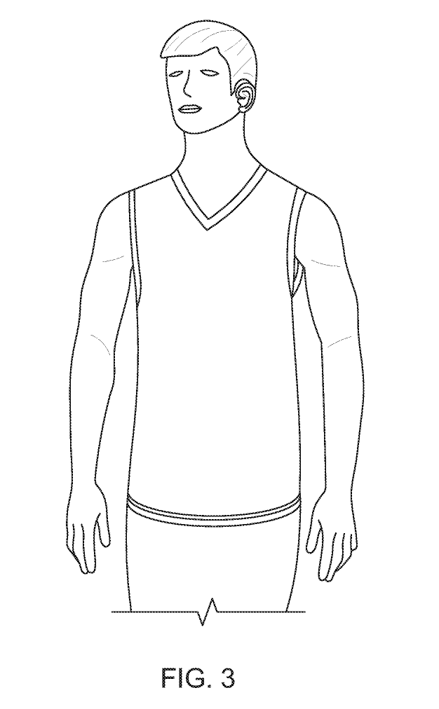

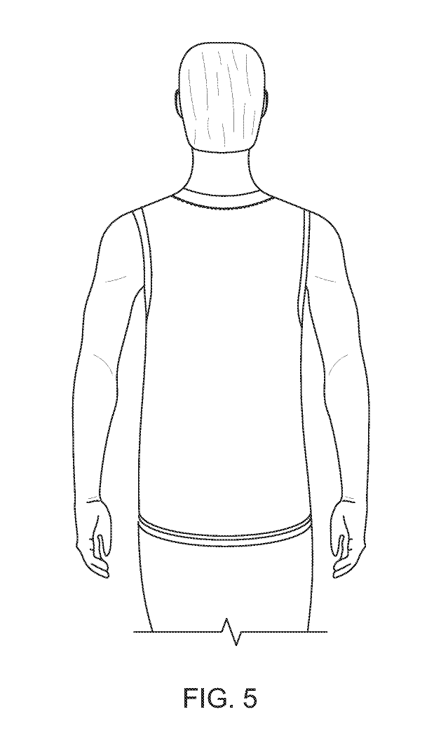

FIG. 3 is a perspective view of the sports jersey as worn by an athlete. FIG. 4 is a perspective view of the sports jersey, turned inside-out, as worn by an athlete. FIG. 5 is a rear view of the sports jersey as worn by an athlete. As shown in FIGS. 3-5, the sweat absorbing material is not visible in situations where the sports jersey is worn by the athlete.

FIG. 6 is a perspective view of the sports jersey, and depicts a method of removing sweat from a person wearing a sports jersey shirt during an athletic event. For example, as shown in FIG. 6, the athlete may wear a sleeveless sports jersey shirt, and lift-up the sports jersey shirt to expose a sweat absorbing material located only on an inside of the sports jersey shirt. The athlete may then wipe sweat from the athlete's face onto the sweat absorbing material.

The foregoing disclosure provides illustration and description, but is not intended to be exhaustive or to limit the implementations to the precise form disclosed. Modifications and variations are possible in light of the above disclosure or may be acquired from practice of the implementations.

Even though particular combinations of features are disclosed in the specification, these combinations are not intended to limit the disclosure of possible implementations. In fact, many of these features may be combined in ways not specifically disclosed in the specification.

No element or feature used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A sports jersey, comprising:
a jersey shirt made of a non-sweat absorbing material, the jersey shirt having a sweat absorbing material located only on an inside upper portion of the jersey shirt.

2. The sports jersey of claim 1, wherein the non-sweat absorbing material is nylon, and the sweat absorbing material is at least one of cotton, terry cloth, bamboo, and linen.

3. The sports jersey of claim 1, wherein the sports jersey shirt is a basketball sleeveless jersey shirt.

4. A method of removing sweat from a person wearing a sports jersey shirt during an athletic event, comprising the steps of:
wearing the sports jersey shirt made of a non-sweat absorbing material, the sports jersey shirt having a sweat absorbing material located only on an inside upper portion of the sports jersey shirt;
lifting-up the sports jersey shirt to expose the sweat absorbing material located only on the inside of the sports jersey shirt; and
wiping sweat from the person's face onto the sweat absorbing material.

5. The method of claim 4, wherein the non-sweat absorbing material is nylon, and the sweat absorbing material is at least one of cotton, terry cloth, bamboo, and linen.

6. The method of claim 4, wherein the sports jersey shirt is a basketball sleeveless jersey shirt.

7. A sports garment, comprising:
a shirt made of a non-sweat absorbing material, the shirt having a sweat absorbing material located only on an inside upper portion of the shirt.

8. The sports garment of claim 7, wherein the non-sweat absorbing material is nylon, and the sweat absorbing material is at least one of cotton, terry cloth, bamboo, and linen.
